(19) United States
(12) Patent Application Publication
(10) Pub. No.: US 2016/0239370 A1
(43) Pub. Date: Aug. 18, 2016

(54) RACK HAVING AUTOMATIC RECOVERY FUNCTION AND AUTOMATIC RECOVERY METHOD FOR THE SAME

(71) Applicant: AIC INC., Taoyuan Hsien (TW)

(72) Inventors: Yen-Yu CHEN, Taoyuan Hsien (TW); Wan-Chun YEH, Taoyuan Hsien (TW); Yu-Heng SU, Taoyuan Hsien (TW); Shih-Chieh HSU, Taoyuan Hsien (TW)

(21) Appl. No.: 14/621,262

(22) Filed: Feb. 12, 2015

(51) Int. Cl. G06F 11/07

(52) U.S. Cl. CPC G06F 11/0793; G06F 11/0709

(57) ABSTRACT

A rack comprising a control module and a plurality of nodes is present. The control module comprises a rack management controller (RMC), and each of the plurality of nodes comprises a baseboard management controller (BMC). The RMC communicates with the BMCs respectively through a plurality of default communication channels, and the RMC controls the nodes and transmits necessary data thereto through the BMCs. When losing response signal from one of the BMCs, the RMC resends same signal to the non-responded BMC. If a resend threshold is achieved, the RMC sends a control signal to a reset pin of the non-responded BMC directly through a GPIO channel to force the non-responded BMC to reset.

### BACKGROUND OF THE INVENTION

1. Field of the Invention

The invention relates to a rack, and in particularly to a rack having automatic recovery function, and an automatic recovery method used by the rack.

2. Description of Prior Art

Generally, each server arranged in a rack respectively comprises a baseboard management controller (BMC), and the servers respectively use the BMCs to control and maintain themselves.

The rack usually comprises a rack management controller (RMC), used to communicate with the BMCs in the servers. The rack uses the RMC to control the servers, collect information from the servers, and transmit files needed by the servers (such as updated files for updating a firmware) through the BMCs.

In the related art, the RMC basically communicates with the BMCs through communication channels such as intelligent platform management bus (IPMB), inter-integrated circuit (I²C) or local area network (LAN), and uses the communication channels to transmit control command, information and files.

However, each communication channel mentioned above is bi-directional. More specific, if the RMC wants to communicate with a target BMC, it needs to send an initial ASK signal to the target BMC in advance. After receiving a RESPONSE signal from the target BMC, the RMC can make sure that the communication channel is flowing, and the then transmit real data to the target BMC. In other words, if the target BMC itself or a communication interface of the BMC has a problem (for example, a firmware failure or hardware signal mistake), such that the target BMC cannot response the ASK signal from the RMC, the RMC cannot communication with the target BMC successfully.

In the current rack, each server in the rack is configured with a watchdog function, which can detect problems of the BMC and reset the BMC automatically when the BMC do have a problem. However, the watchdog function mentioned above can only detect some specific failure (for example, the whole BMC shuts down). In some situations, the watchdog function cannot accurately detect what happens to the BMC and will not reset the BMC automatically. As a result, the RMC can only notify a manager of the rack by itself (for example, makes an alert via a buzzer or a LED thereof, sends e-mail or MMS to the manager, etc.).

If the manager receives above alert, he or she will reset the BMC manually (for example, pulls the server from the rack (for interrupting a power of the BMC), and then inserts the server into the rack again (for resetting the BMC)).

As described above, the communication problem between the RMC and the BMC can only be solved manually in the related art, it is very inconvenient. Also, if the rack is sold to a client and the client lacks the ability for solving the above problem, the client needs to send the rack or the server back to the original factory for fixing, or to ask the manager to fix the rack or the server at the client directly.

### SUMMARY OF THE INVENTION

The object of the present invention is to provide a rack having automatic recovery function and an automatic recovery method used by the rack, which can reset a baseboard management controller (BMC) to recover to an initial status when a rack management controller (RMC) in the rack cannot communicate with the BMC in a node of the rack regularly.

According to the above object, the present invention discloses a rack comprising a control module and a plurality of nodes. The control module comprises the RMC, and each of the plurality of nodes comprises the BMC. The RMC communicates with the BMCs respectively through a plurality of default communication channels, and the RMC controls the nodes and transmits necessary data thereto through the BMCs. When losing response signal from one of the BMCs, the RMC resends same signal to the non-responded BMC. If a resend threshold is achieved, the RMC sends a control signal to a reset pin of the non-responded BMC directly through a GPIO channel to force the non-responded BMC to reset.

Comparing with related art, the present invention can force a BMC to reset and recover to an initial status through a simple and stable hardware function whenever the BMC has a problem and cannot communicate with the RMC in the rack. The RMC can establish a communication channel with the BMC again after the BMC recovers to the initial status. Therefore, the present invention can make sure the RMC can always control all BMCs in the rack in any situation.

### BRIEF DESCRIPTION OF THE DRAWINGS

FIG. 1 is a schematic view of a rack of a first embodiment according to the present invention.

FIG. 2 is a connection diagram of a first embodiment according to the present invention.

FIG. 3 is a connection diagram of a second embodiment according to the present invention.

FIG. 4 is a reset flowchart of a first embodiment according to the present invention.

### DETAILED DESCRIPTION OF THE INVENTION

In cooperation with the attached drawings, the technical contents and detailed description of the present invention are described thereinafter according to a preferable embodiment, being not used to limit its executing scope. Any equivalent variation and modification made according to appended claims is all covered by the claims claimed by the present invention.

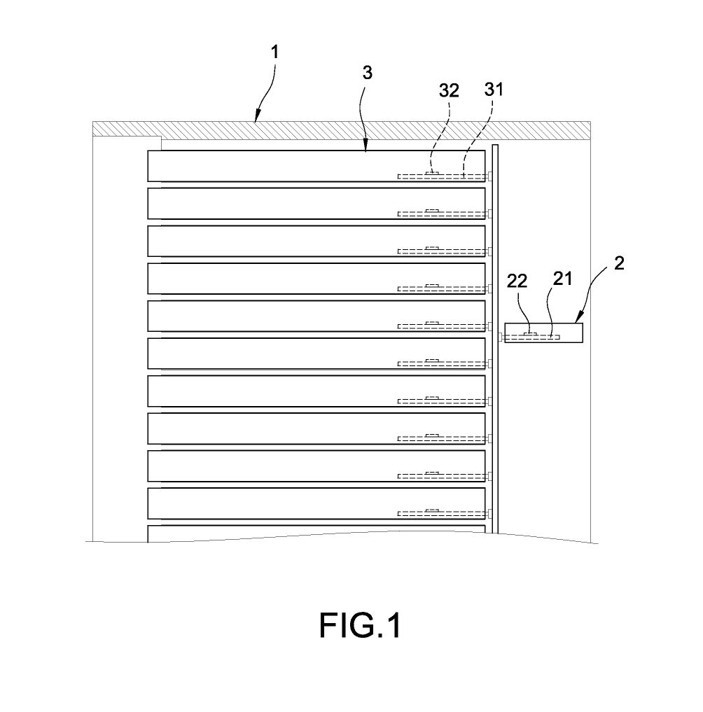

FIG. 1 is a schematic view of a rack of a first embodiment according to the present invention. The present invention discloses a rack 1 which has an automatic recovery function detailed described below. In particularly, the rack 1 comprises a control module 2 and a plurality of nodes 3, wherein the control module 2 at least comprises a circuit board 21 and a rack management controller (RMC) 22 electrically connected with the circuit board 21, and each of the plurality of nodes 3 respectively comprises a baseboard 31 and a baseboard management controller (BMC) 32 electrically connected with the baseboard 31. The automatic recovery function in the present invention is, for example, a reset action executed for recovering the BMCs 32 in the nodes 3 to an initial status free from communication problems.

The control module 2 and the nodes 3 are respectively arranged in the rack 1, and the control module 2 is electrically connected with each node 3. As a result, the RMC 22 in the control module 2 can communicate with each BMC 32 in each node 3, and can control all of the nodes 3, collect information from the nodes 3 and transmit necessary files (for example, updated file for updating a firmware) to the nodes 3 via the BMCs 32.

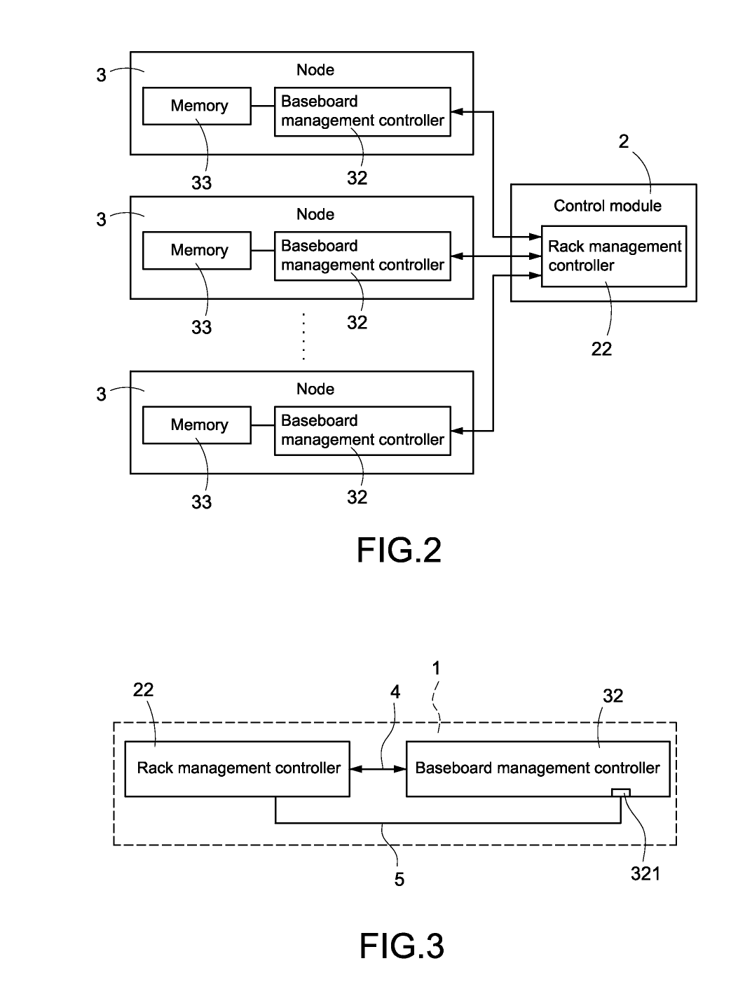

FIG. 2 is a connection diagram of a first embodiment according to the present invention. As shown in FIG. 2, the RMC 22 in the control module 2 is connected with the BMCs 32 in the nodes 3 respectively through a plurality of default communication channels 4. In this embodiment, the default communication channels 4 are accomplished by intelligent platform management bus (IPMB), inter-integrated circuit (I²C), universal asynchronous receiver/transmitter (UART) or local area network (LAN), but not limited thereto. The RMC 22 communicates with the BMCs 32 through the plurality of default communication channels 4 respectively, and transmits files needed by the nodes 3 to the BMCs 32 through the plurality of default communication channels 4, so the BMCs 32 can use the files continently.

For example, each of the plurality of nodes 3 respectively comprises a memory 33 electrically connected to the BMC 32 therein. Each memory 33 stores a basic input/output system (BIOS) needed by the node 3 the memory 33 arranged. When the BIOSs of the nodes 3 need to be updated, the RMC 22 receives the updated file externally (for example, an “*.ISO” file), and transmits the updated file to the BMCs 32 through the default communication channels 4 respectively. Therefore, the BMCs 32 use the received updated file to update the BIOSs in the memories 33 respectively.

For completing an updating action mentioned above, the RMC 22 needs to send a ASK signal to the BMCs 32 through the default communication channels 4 respectively in advance before transmitting files to the BMCs 32. After receiving a RESPONSE signal corresponding to the ASK signal from the BMCs 32 respectively, the RMC 22 determines that the BMCs 32 are regular and the default communication channels 4 are flowing. Therefore, the RMC 22 can transmit the files needed by the nodes 3 to the BMCs 32 through the default communication channel 4 respectively.

On the contrary, if one of the plurality of BMCs 32 does not respond to the RMC 22 (i.e., the plurality of BMCs 32 comprises at least one non-responded BMC 32), the RMC 22 cannot communication with the non-responded BMC 32 and cannot transmit the files to the non-responded BMC 32. For solving this problem, the RMC 22 in the present invention can control the non-responded BMC 32 through other simple and stable hardware function, so as to recover the BMC 32 from a non-responded status to the initial status which is regular.

FIG. 3 is a connection diagram of a second embodiment according to the present invention. In FIG. 3, an amount of the BMCs 32 in the rack 1 is depicted by 1 for example, but not intended to limit the scope of the present invention.

The main technical characteristic of the rack 1 in the present invention is that the RMC 22 is electrically connected to the circuit board 21, the BMC 32 is electrically connected to the baseboard 31, and at least one control pin (not shown) of the RMC 22 is electrically connected to a reset pin 321 of the BMC 32 directly through the circuit board 21 and the baseboard 32. More specific, the RMC 22 in this embodiment is electrically connected to the reset pin 321 of the BMC 32 directly through a general purpose I/O (GPIO), and establishes a GPIO channel 5 with the BMC 32.

By using the technical solution disclosed in the present invention, if the RMC 22 sends the ASK signal to the BMC 32 and does not receive the RESPONSE signal corresponding to the ASK signal from the BMC 32 after a waiting time, the BMC 32 is considered to as a non-responded BMC 32. The RMC 22 resends the same ASK signal to the non-responded BMC 32 again. If a resend time of resending the ASK signal is longer than a resend threshold, the RMC 22 determines that the non-responded BMC 32 has some problem (i.e., the non-responded BMC 32 is considered to as a problematic BMC 32).

In this embodiment, when determining the non-responded BMC 32 is the problematic BMC 32, the RMC 22 controls the problematic BMC 32 through the GPIO channel 5. In particularly, the RMC 22 sends a control signal (through the control pin) to the reset pin 321 of the problematic BMC 32 directly through the GPIO channel 5, so as to force the problematic BMC 32 to reset.

For example, the RMC 22 is set to output a low potential signal (such as “0”) or not output any signal via the control pin in a normal operation, and when above problem occurs, the RMC 22 changes to output a high potential signal (such as “1”). If the problematic BMC 32 receives the high potential signal at the reset pin 321, it is forced to reset. However, the above description is just a preferred embodiment, but not limited thereto.

As mentioned above, no matter what problem the BMC 32 has and causes the RMC 22 to fail to communicate with the BMC 32 through the default communication channel 4, the RMC 22 can always force the BMC 32 to reset through the GPIO channel 5, so as to recover the BMC 32 to the initial status. Also, the RMC 22 can establish a connection with the BMC 32 again through the default communication channel 4 after the BMC 32 is recovered to the initial status, and communicates with the recovered BMC 32 and transmits data therewith. There is no need to wait for a manager to recover the above problem manually when the RMC 22 cannot communicate with the BMC 32 regularly.

In other embodiments, the RMC 22 can interrupt the power provided for the BMC 32 and then recover the power for the BMC 32 through the GPIO channel 5, or interrupt the power provided for the node 3 the BMC 32 arranged and then recover the power for the node 3, so as to accomplish the purpose for resetting the BMC 32.

In particularly, the rack 1 in this embodiment comprises one or more power control chip (not shown), and the power control chip is electrically connected with the plurality of nodes 3 and a power source of the rack 1. In this embodiment, the RMC 22 connects with the power control chip through the GPIO channel 5. When the RMC 22 cannot communicate with the BMC 32 through the default communication channel 4, it can send a reset command to the power control chip through the GPIO channel 5. The power control chip interrupts the power provided for the node 3 (or for the BMC 32) according to the content of the reset command, and then resend the power for the node 3 (or for the BMC 32) immediately. Therefore, the BMC 32 can be reset, and can recover to the initial status after the reset action is completed.

It should be mentioned that the power control chip in this embodiment can control the power provided for all of the nodes 3, if the power is interrupted without a permission, it will bother the user a lot. In other embodiments, the RMC 22 can generate and display an alert signal in advance before sending the reset command, and only sends the reset command to the power control chip if the user confirms the alert signal and agrees the RMC 22 to execute the reset action. However, the above description is just another preferred embodiment, not intended to limit the scope of the present invention.

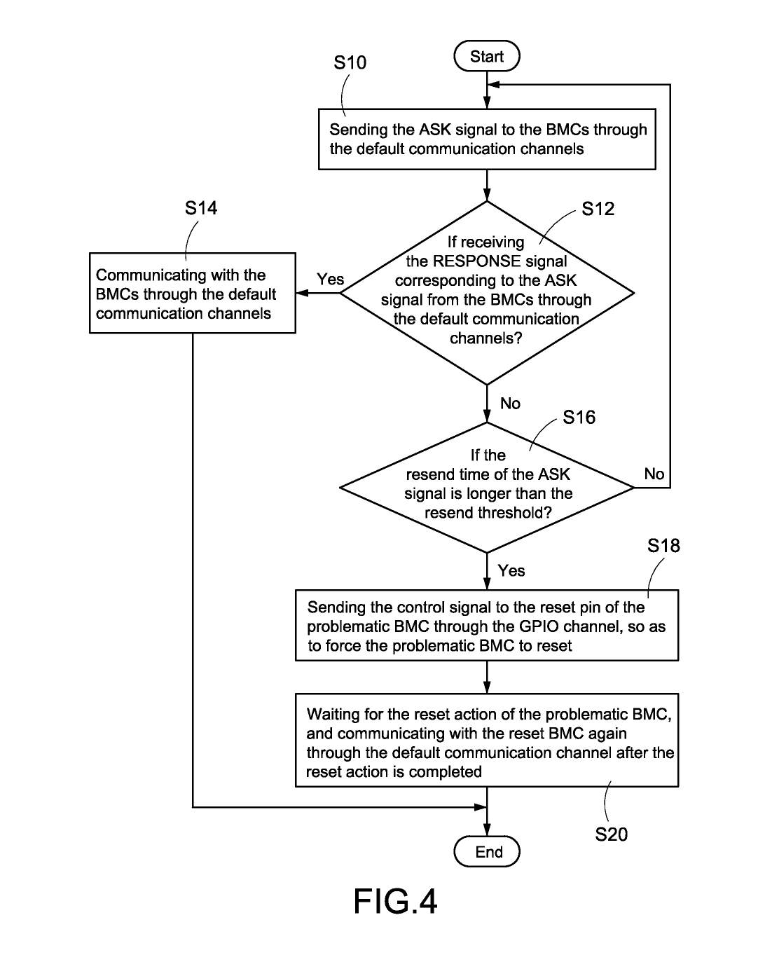

FIG. 4 is a reset flowchart of a first embodiment according to the present invention. As shown in FIG. 4, before the RMC 22 wants to communicate with the BMCs 32, it firstly sends the ASK signal to the BMCs 32 through the default communication channels 4 respectively (step S10). Secondly, the RMC 22 determines if receiving the RESPONSE signal corresponding to the ASK signal from the BMCs 32 through the default communication channels 4 respectively or not (step S12). After the RMC 22 receives the RESPONSE signal from the BMCs 32, it can communicate with the BMCs 32 through the default communication channels 4 respectively (step S14), and transmits data and files needed by the nodes 3 thereto.

Following the above descriptions, if the RMC 22 does not receive the RESPONSE signal from one of the BMCs 32 during the waiting time (i.e., the BMCs 32 comprises at least one non-responded BMC 32), it determines if the resend time of resending the ASK signal is longer than the resend threshold or not (step S16). If the resend time of the ASK signal is not longer than the resend threshold yet, the RMC 22 resends the ASK signal to the non-responded BMC 32 through one of the default communication channels 4 corresponding to the non-responded BMC 32 again, i.e., the RMC 22 re-executes the step S10 to the step S16.

If the resend time of the ASK signal is longer than the resend threshold, the RMC 22 determines the non-responded BMC 32 has a problem and considers the non-responded BMC 32 to as the problematic BMC 32, and sends the control signal to the reset pin 321 of the problematic BMC 32 through the GPIO channel 5, so as to force the problematic BMC 32 to reset (step S18). Furthermore, the RMC 22 waits for the reset action of the problematic BMC 32, and communicates with the reset BMC 32 again through one of the default communication channels 4 after the reset action is completed (step S20).

By using the rack and the automatic recovery method, the present invention can make sure the RMC in the rack can always control all BMCs and recover all BMCs to the initial status in any situation, so as to salve the traditional problem that the RMC cannot communicate with the BMCs through the default communication channels sometimes. Therefore, the present invention helps the rack to solve communication problems by itself and prevent from waiting for the manager to solve the above problems manually.

As the skilled person will appreciate, various changes and modifications can be made to the described embodiment. It is intended to include all such variations, modifications and equivalents which fall within the scope of the present invention, as defined in the accompanying claims.

What is claimed is:

1. A rack having an automatic recovery function, comprising:
at least one node, having a baseboard management controller (BMC);
a control module electrically connected with the node, having a rack management controller (RMC), and the RMC communicating with the BMC through a default communication channel;
wherein, the RMC is electrically connected with the BMC through a general purpose I/O (GPIO) channel, and sends a control signal through the GPIO channel to the BMC to force the BMC to reset when not receiving a RESPONSE signal from the BMC through the default communication channel.

2. The rack according to claim 1, wherein the RMC comprises a control pin, the BMC comprises a reset pin, the control pin of the RMC is electrically connected to the reset pin of the BMC through the GPIO channel.

3. The rack according to claim 2, wherein the control module further comprises a circuit board, the node further comprises a baseboard, the RMC is electrically connected with the circuit board, the BMC is electrically connected with the baseboard, and the control pin of the RMC is electrically connected to the reset pin of the BMC to send the control signal through the circuit board and the baseboard.

4. The rack according to claim 2, wherein the default communication channel is accomplished by intelligent platform management bus (IPMB), inter-integrated circuit (I²C), universal asynchronous receiver/transmitter (UART) or local area network (LAN).

5. The rack according to claim 1, further comprises a power control chip, electrically connected to the node and a power source of the rack, the RMC is connected to the power control chip through the GPIO channel, and sends a reset command to the power control chip when not receiving the RESPONSE signal from the BMC through the default communication channel, and the power control chip interrupts a power provided for the node in accordance with a content of the reset command, and then recover the power provided for the node again.

6. An automatic recovery method for a rack, the rack comprising a control module and a node electrically connected with the control module, the control module comprising a rack management controller (RMC), the node comprising a baseboard management controller (BMC) communicating with the RMC through a default communication channel, and the automatic recovery method comprising:
a) determining if failing to receive a RESPONSE signal from the BMC through the default communication channel at the RMC;
b) if failing to receive the RESPONSE signal from the BMC through the default communication channel at the RMC, sending a control signal to the BMC through a general purpose I/O (GPIO) channel to force the BMC to reset, wherein the RMC and the BMC are electrically connected with each other through the GPIO channel.

7. The automatic recovery method according to claim 6, wherein the RMC comprises a control pin, the BMC comprises a reset pin, the control pin of the RMC is electrically connected to the reset pin of the BMC through the GPIO channel to send the control signal.

8. The automatic recovery method according to claim 7, further comprises a step a0 before the step a: sending an ASK signal to the BMC through the default communication channel at the RMC.

9. The automatic recovery method according to claim 8, wherein the step a comprises following steps of:
a1) determining if receiving the RESPONSE signal corresponding to the ASK signal from the BMC through the default communication channel;
a2) determining if a resent time of the ASK signal is longer than a resend threshold or not when not receiving the RESPONSE signal;
a3) resending the ASK signal to the BMC through the default communication channel if the resend time is not longer than the resend threshold;
a4) executing the step b if the resend time is longer than the resend threshold.

10. The automatic recovery method according to claim 9, further comprises a step c: after the step b, waiting for a reset action of the BMC and communicating with the BMC again through the default communication channel after the reset action is completed.
